(19) United States
(12) Patent Application Publication
(10) Pub. No.: US 2002/0156864 A1
(43) Pub. Date: Oct. 24, 2002

(54) System for wireless exchange of data with hand held devices

(76) Inventor: James Newton Kniest, Edmonds, WA (US)

Correspondence Address: Patrick M. Dwyer PC, Suite 114, 1818 Westlake Avenue N, Seattle, WA, 98109, US

(21) Appl. No.: 09/876,191

(22) Filed: Jun. 6, 2001

Related U.S. Application Data
(60) Provisional application No. 60/209,882, filed on Jun. 6, 2000.
(60) Provisional application No. 60/229,973, filed on Sep. 2, 2000.
(60) Provisional application No. 60/242,963, filed on Oct. 23, 2000.
(60) Provisional application No. 60/245,517, filed on Nov. 3, 2000.

(51) Int. Cl. G06F 15/16

(52) U.S. Cl. 709/217; 709/227

(57) ABSTRACT

WebAngel is configurable to automatically fetch Internet content “favorites” based on a timer or any other selected condition. Environmental changes also trigger WebAngel to automatically fetch Internet content “favorites” based on a timer event or any environ mental condition. WebAngel is a pre-fetching engine (or user agent) that gathers local environmental parameters, sends them to an “analysis module” which arranges for advance sending of only that data that meets the requirement of the environmental data.

The following wireless devices pertain to this application. The term “Wireless Devices” encompasses all these devices unless specifically stated otherwise.

Handheld Web Based CD Players/Recorders

Handheld Web Based Cassette Player/Recorders

Handheld Web Based Digital Audio Tape (DAT) Player/Recorders

Handheld Web Based Video Gamer

Handheld Web Based Gamer & RC Controller

Web Based Handheld Book/Periodical “Reader”

Web Based Portable Music Synthesizers

Medical Image Reviewer

Medical Ultrasound System

Wearable Versions of the above Devices

Context Diagram

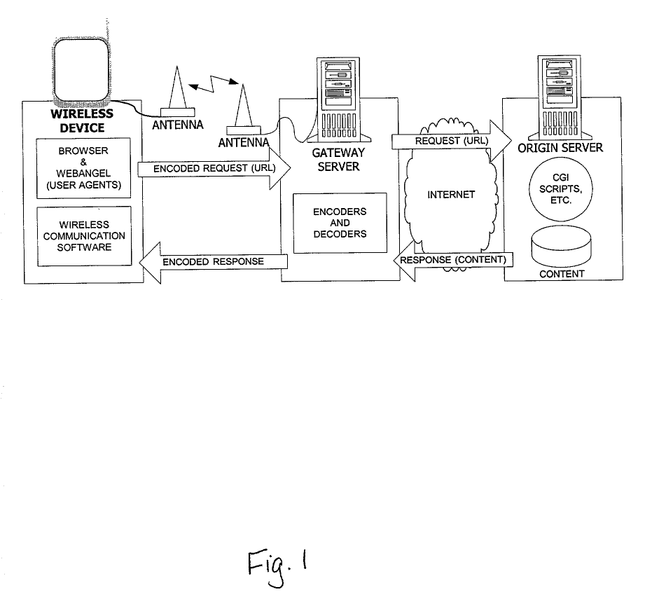

(See FIG. 1—WWW Wireless Logical Model with Encoded Data)

Web-Enabled Wireless Device Market Potential

One Billion Mobile Web-Enabled Wireless Devices by 2003 according to the Yankee Group (Boston)

Example Partners in Services and Products

| Company | Service/Technology |
|---|---|
| Palm ™ (3Com ™) | Palm OS ™ & |
| | Palm ™ Electronic Hardware Design |
| BellSouth ™ | Wireless Data Network |
| 3Com ™ | Servers/Data Center & Internet Connection |
| Yahoo ™ | Content |
| YellowPages.com ™ | Content |
| WebAngel ™ | Browser Enhancement Software |

Why Make Wireless Devices PalmÖ Compatible?

Fastest Time to Market

Leverage off Other Applications

Open Architecture

Most Advanced Wireless Solution for Handhelds

All Wireless Devices Have a Built in Global Positioning System

What is GPS?

Global Positioning Systems (GPS) are space-based radio positioning systems that provide 24 hour three-dimensional position, velocity and time information to suitably equipped users anywhere on or near the surface of the Earth (and sometimes off the earth).

For More Detailed Information

http://www.trimble.com/gps

What does GPS do for Owners of Wireless Devices?

The answer will become clear after the WebAngel section below

Handheld Web Based CD Player/Recorders

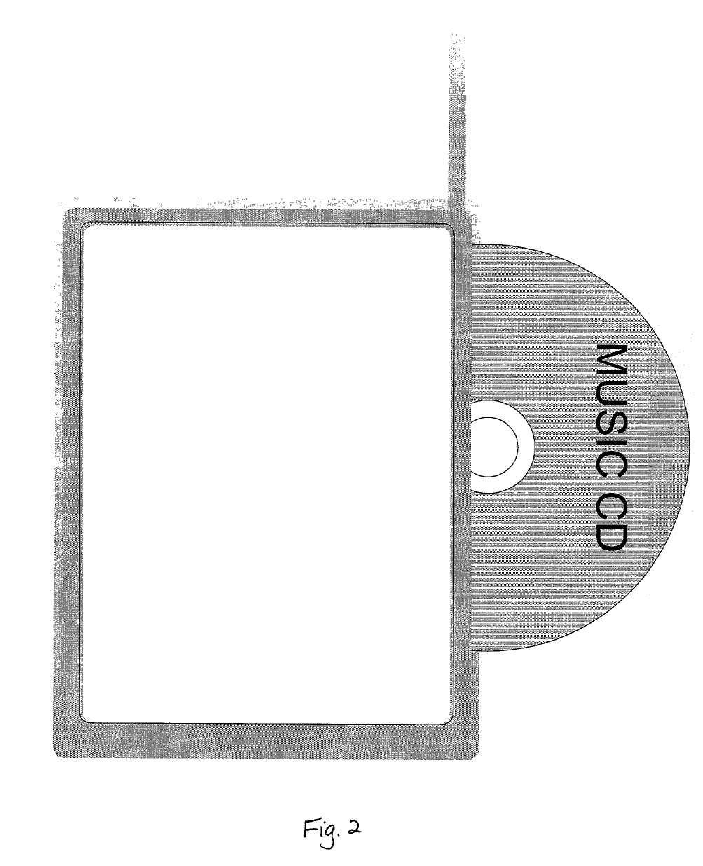

(See FIG. 2)

Combines CD Player/Recorder, MP3 Player, GPS and PalmÖ PDA

Features

Listen to any Music CD with Headphone Output

AM/FM Radio

Web Browser

WebAngel User Agent

Write any Downloaded Internet Content to CD

MP3 Format Music Files

Other Compressed Audio Files

Other Files

Read WinX & Mac Compatible Files into Device from CD

Display any XML/VML Format Internet Content

All Palm™ Basic Applications Included

Core Organizing Applications

Date Book

Address Book

To Do List

Memo Pad

Wireless Internet Messaging

Color Touch Screen Display

Battery or AC Adapter Powered

Cradle Compatible with iRDA Port

Upload CD Files to Host PC/Mac through iRDA Port

Handheld Web Based Cassette Player/Recorders

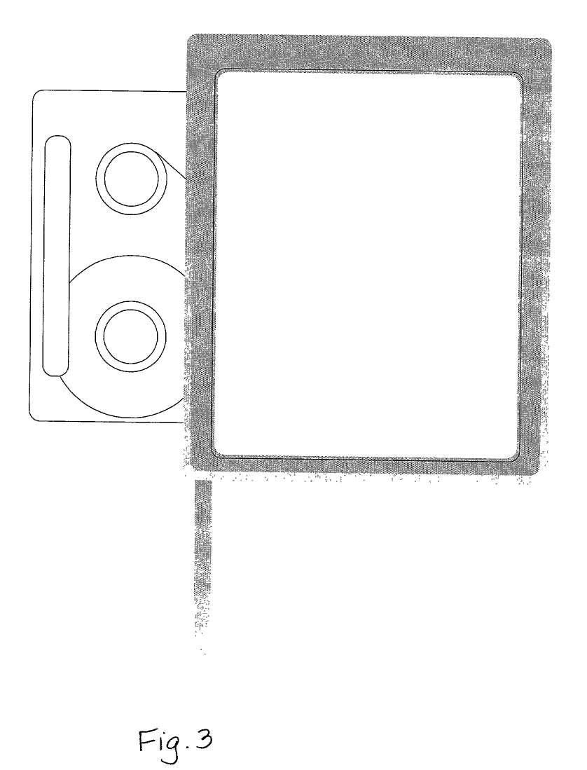

(See FIG. 3)

Listen to any Music Cassette with Headphone Output

AM/FM Radio

Web Browser

WebAngel User Agent

Write any Downloaded Internet Content to Cassette

MP3 Format Music Files (Analog, Possibly Digital

Other Compressed Audio Files (Analog, Possibly Digital)

Other Files (if Digital)

Read WinX & Mac Compatible Files into Device from Cassette

Display any XML/VML Format Internet Content

All Palm™ Basic Applications Included

Core Organizing Applications

Date Book

Address Book

To Do List

Memo Pad

Wireless Internet Messaging

Color Touch Screen Display

Battery or AC Adapter Powered

Cradle Compatible with iRDA Port

Upload CD Files to Host PC/Mac through iRDA Port

Headphone Compatible Output

Handheld Web Based Digital Audio Tape Player/Recorders

(See FIG. 3)

Combines DAT Player/Recorder, MP3 Player, GPS and PahmÖ PDA

Listen to any Music DAT with Headphone Output

AM/FM Radio

Web Browser

WebAngel User Agent

Write any Downloaded Internet Content to DAT

MP3 Format Music Files (Analog, Possibly Digital)

Other Compressed Audio Files (Analog Possibly Digital)

Other Files (if Digital)

Read WinX & Mac Compatible Files into Device from DAT

Display any XML/VML Format Internet Content

All Palm™ Basic Applications Included

Core Organizing Applications

Date Book

Address Book

To Do List

Memo Pad

Wireless Internet Messaging

Color Touch Screen Display

Battery or AC Adapter Powered

Cradle Compatible with iRDA Port

Upload CD Files to Host PC/Mac through iRDA Port

Headphone Compatible Output

Portable Player/Recorders (Boomboxes)

Built in Stereo Amplifier and Speakers

CD Player/Recorder

Cassette Player/Recorder

AM/FM Radio

Web Browser

WebAngel User Agent

Write any Downloaded Internet Content to CD

MP3 Format Music Files

Other Compressed Audio Files

Other Files

Read WinX & Mac Compatible Files into Device from CD

Display any XML/VML Format Internet Content

All Palm™ Basic Applications Included

Core Organizing Applications

Date Book

Address Book

To Do List

Memo Pad

Wireless Internet Messaging

Color Touch Screen Display

Battery or AC Adapter Powered

Cradle Compatible with iRDA Port

Upload CD Files to Host PC/Mac through iRDA Port

Headphone Compatible Output

Easy to Carry Handle

Battery or AC Adapter Powered

iRDA Port

Combines CD & Cassette Player/Recorder, MP3 Player, GPS and Palm™ PDA

Handheld Web Based Video Gamer Devices

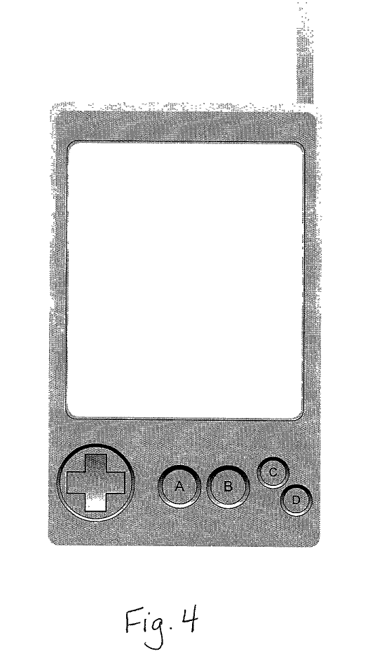

(See FIG. 4)

WebGamer Combines Nintendo Gameboy, MP3 Player, GPS and PalmÖ PDA

WebRCgamer Combines Nintendo Gameboy, RC Controller, MP3 Player, GPS and PalmÖ PDA

Radio Remote Toys Controlled by WebRCgamer

Cars, Boats, Airplanes, Airships with Built in Video Cameras and Microphones Bluetooth and/or Other Radio Frequency Protocol for Communication Between Toy and WebRCgamer Controller

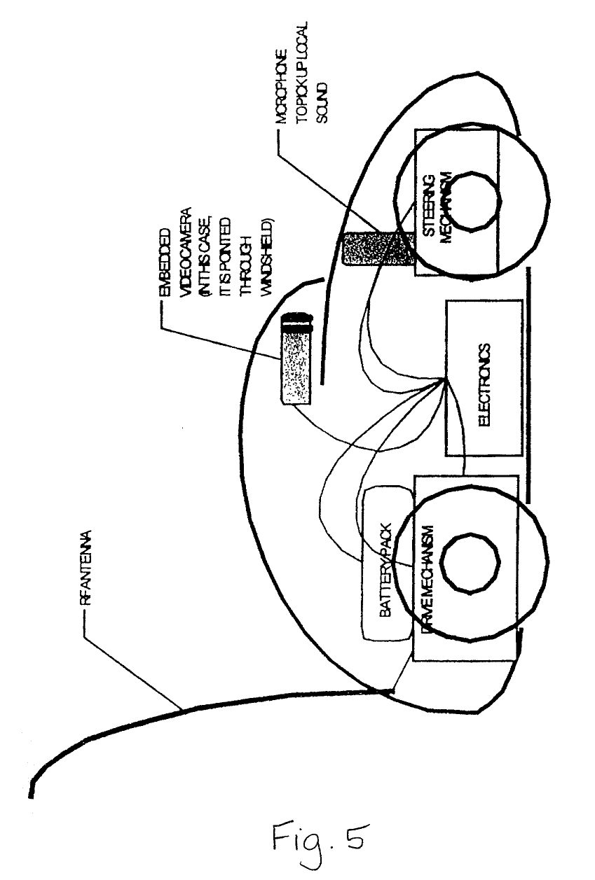

(See FIG. 5)

WebRCgamer Controls Vehicle and Provides Video Image and Audio Playback of Actually “Being” in the Vehicle!

Laser Tag with Radio Remote Vehicles!

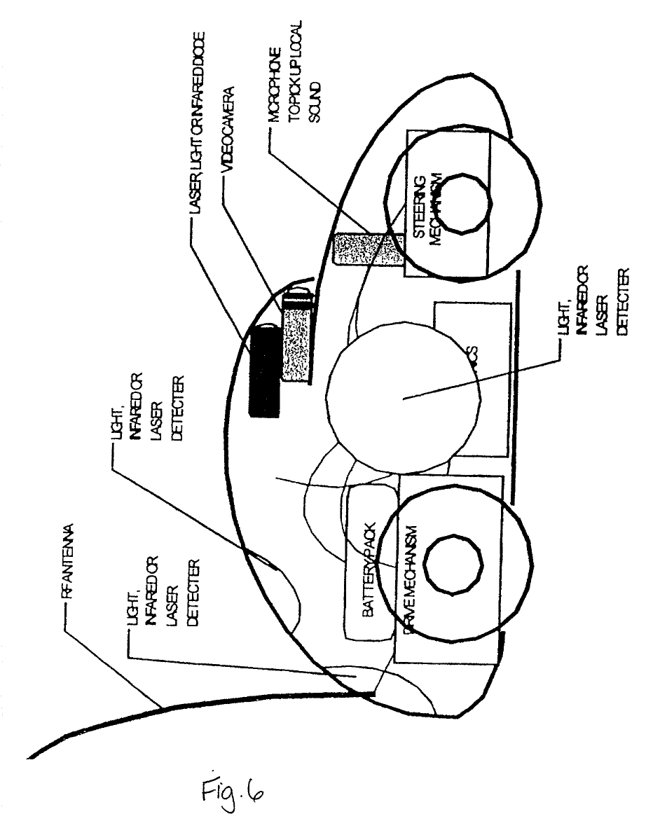

(See FIG. 6)

Players “Shoot” at Each Other! WebRCgamer Keeps Score!

Alternative Technologies to “Shoot” Each Other

Radio Waves

Ultrasound

Video Camera and Microphone are Optional

Handheld Web Based Book/Periodical Reader

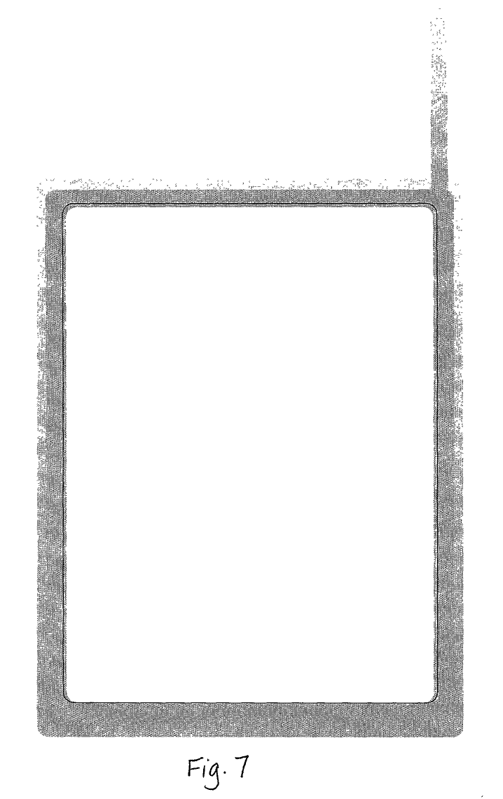

(See FIG. 7)

Combines Palm PDA, MP3 Player, GPS and SoftReaderÖ

With WebReader one could be Reading a “Free” Book off the Web

Advertising Embedded in Book

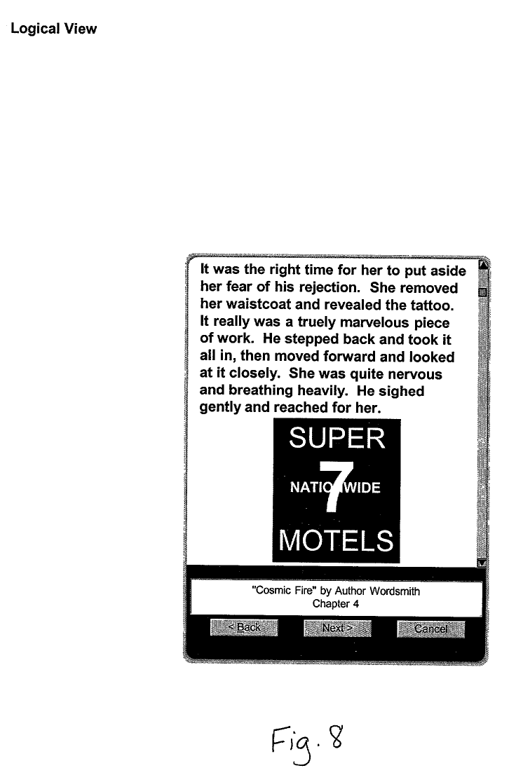

(See FIG. 8)

Adjustable Font Size for Easy Reading

One can Listen to a Book off the Web

Keeping the Reader's Voice Output (Like a Book on Tape)

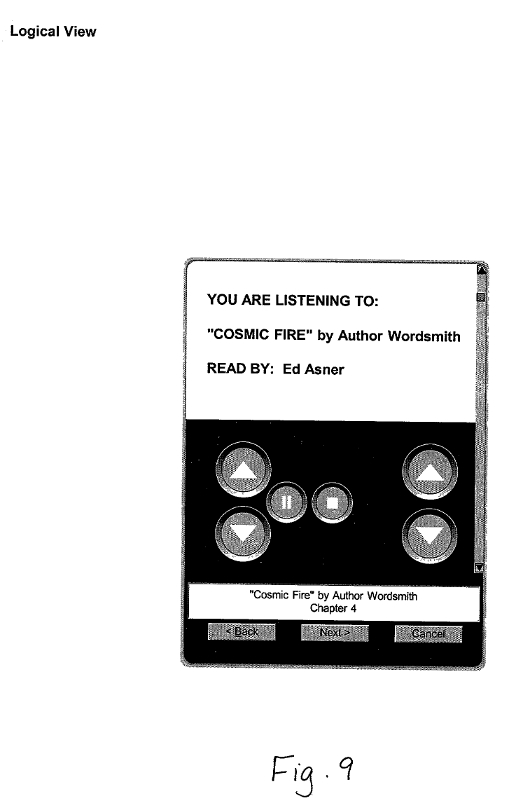

(See FIG. 9)

Controls

Volume

Playback Speed Without Affecting Speech Timbre

Pause

Stop

Play

Sharing a Book—Mom's Away on a Business Trip

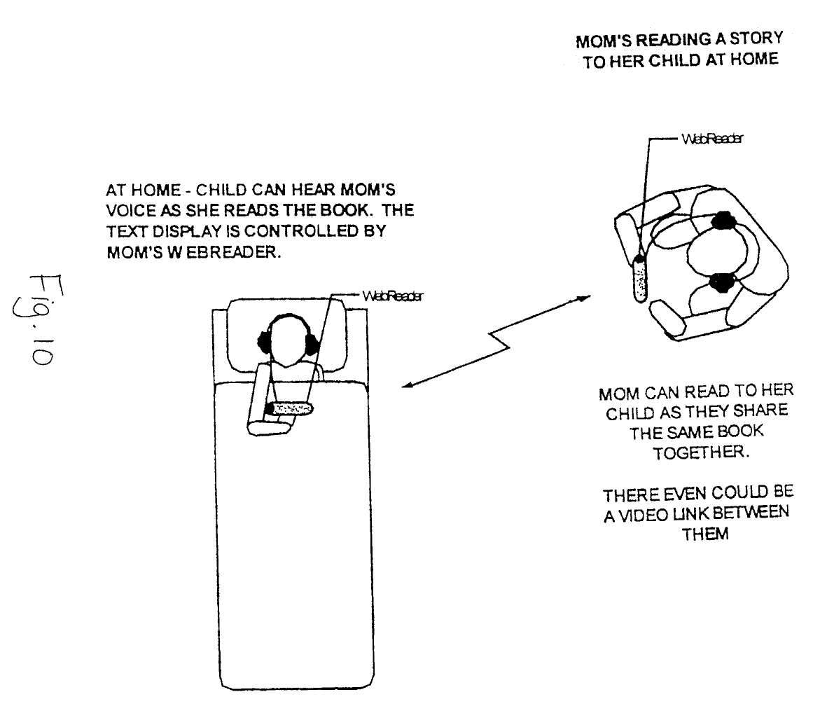

(See FIG. 10)

Feature Summary

Downloads Desired Reading Material off the Web

Color Touch Screen Display

Adjustable Playback Speed

Speech Engine for Accurate Cadence and Timbre

Text to Speech Engine for Text Only Input

“Outdoor” Case

Web Browser

WebAngel™ User Agent

Headphone Compatible Output

Headphones

Battery or AC Adapter Powered

Cradle Compatible with iRDA Port

Potential for at Least Two Product Offerings

WebReader 101

All Features Listed Above

WebReader 303

All Features Listed Above

“Sharing a Book” Capability

Music Synthesizers

Synthesizers with Physical Modeling Technology

What is Physical Modeling?

Computer Simulates Actual Operation of Musical Instruments

More Accurate Sound Synthesis of Practically Any Instrument Imaginable

More Dynamic than Sampled or Additive Synthesis

For The Piano

Digital Waveguides to Simulate Vibration Modes of the String

Simulates Piano Hammer Striking a String

Simulating the Sound Board and Piano Body

Capturing the “Soul” of the Piano

Extremely Complicated Instrument

Current Distal Pianos and Synthesizers are Still Inadequate

Processing Power Now a Possibility for Incredible Piano Emulation

High Speed Floating Point Digital Signal Processors Possible

Multiple Floating Points DSPs on a Single Die

RAM Costs Dramatically Reduced

Other Instruments (Patches) must be Available

General MIDI Specification—Over a 128 Different Instruments

Kniest Instruments Meet General MIDI and XG® Requirements

License Technology for Outside Sources

Kniest Synths can Change Instrument Materials for Different Sounds

Steel Clarinet

Wood Tuba

Plastic Flute

Mix and Match!

Clarinet Mouthpiece—Tuba Body

Trumpet Mouthpiece—Clarinet Body

Violin Bow on Piano (Instead of Hammer)

Piano Hammer on Guitar

Mobile Medical Assistant

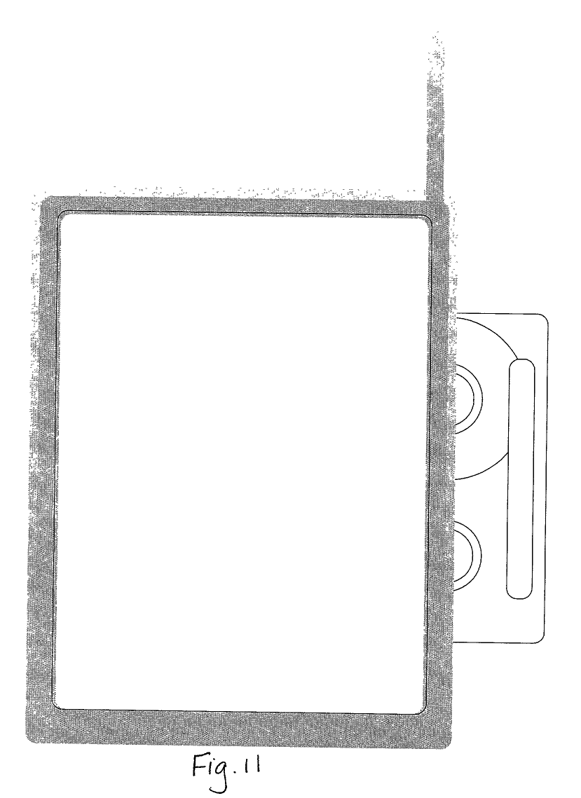

(See FIG. 11)

[image]

Remote Diagnosis Context Diagrams

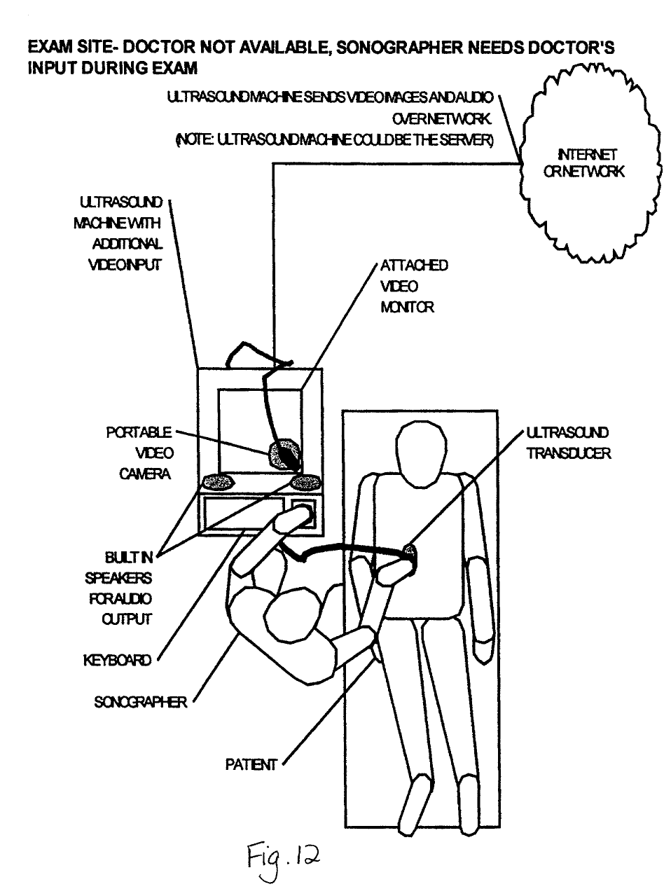

(See FIG. 12)

Context Diagrams—Continued

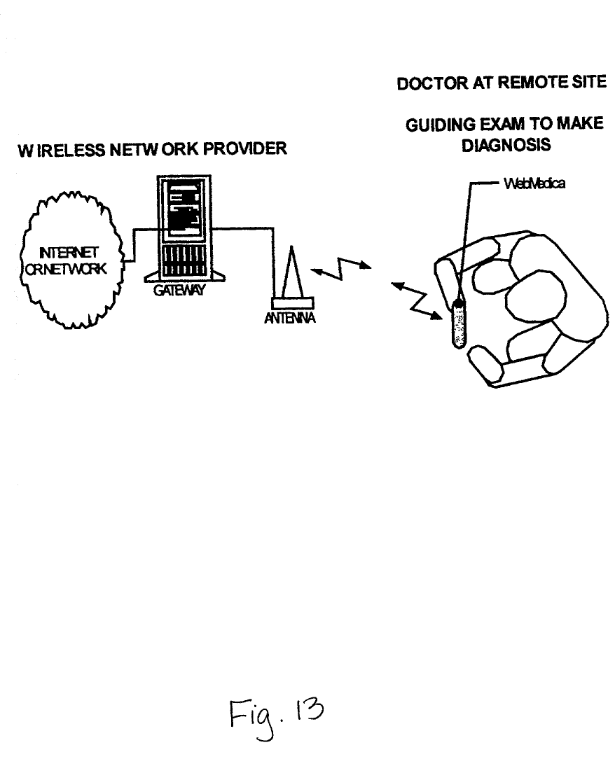

(See FIG. 13)

Remote Diagnosis Scenario

In this scenario, the doctor is guiding the exam remotely. The doctor in this case could be an OB-Gyn who is at home while one of his/her patients is in labor. Before deciding to go in to meet with the patient (in person), the doctor may direct the sonographer on where to “look” or place the probe on the patient's body.

Ultrasound Image and Video Camera Image on WebMedica Display

The WebMedica has two images on the display, the ultrasound image generated by the ultrasound machine and the camera output to help the doctor see where the transducer is placed on the woman's body. The camera output is processed by the ultrasound machine (or some other device) and sent to the server. The doctor has the option of controlling the video camera from WebMedica. Video camera control consists of focus, panning and zooming.

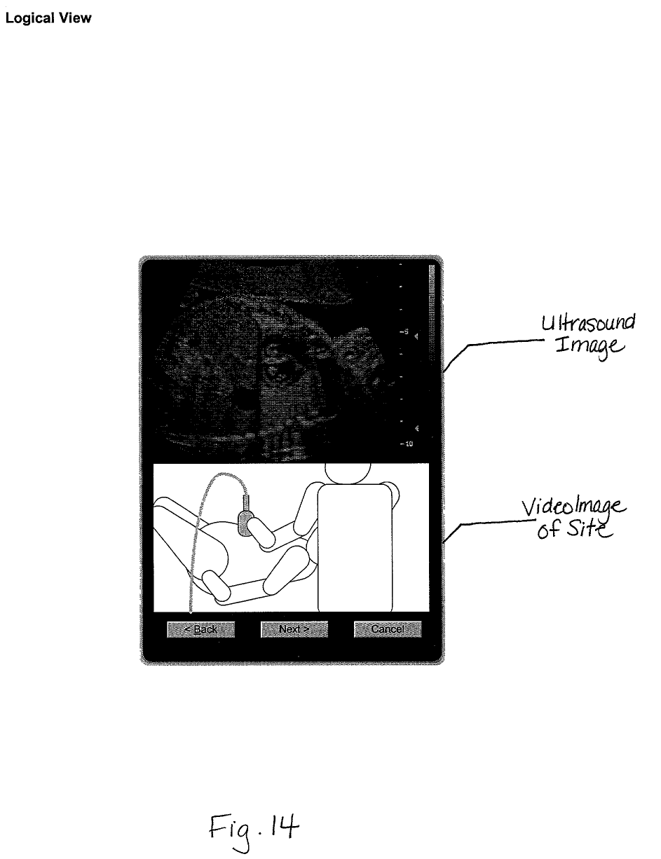

(See FIG. 14)

Doctor Provides Direction on Transducer Placement

The doctor provides direction to the sonographer by speaking into the WebMedica microphone, which records the voice input and sends it back to the ultrasound machine. The ultrasound machine outputs the doctor's orders through its embedded audio/speaker system.

Doctor and Patient Conference Capabilities

The doctor could also converse with the patient directly through the same medium.

It is conceived that some WebMedica devices could have a built in (or attachable) video camera to provide an image of the user back to the ultrasound machine. The ultrasound machine would output the video image on its monitor. Essentially then, it would be a “video conference” with the handheld device being one terminal, and the ultrasound machine being the other!

Remote Ultrasound Machine Control

The doctor could also CONTROL the settings on the ultrasound machine through WebMedica. This would reduce the technical requirements of the sonographer. It is conceived that the sonographer could be anyone willing to hold the transducer on the patient with guidance from a qualified medical professional.

Not Limited to Ultrasound Applications

This scenario is not limited to ultrasound applications. It is conceived that it could be used with any medical imaging modality.

Ultrasound Transducer Blanket System

Transducer “Blanket” Wrapped around (or Placed on) Patient

Blanket has Multiple Transducer Assemblies Embedded in it Ultrasound Machine uses one Transducer Assembly at a Time (Multiplexed)

Requires no Technical Expertise to Capture Medical Images

Good for Remote Diagnosis

Blanket has Velcro Strips Outside

Keep it in Place During Exam

Adjustable for Different Parts of the Body

Ultrasound Transducer Blanket System Context Diagram

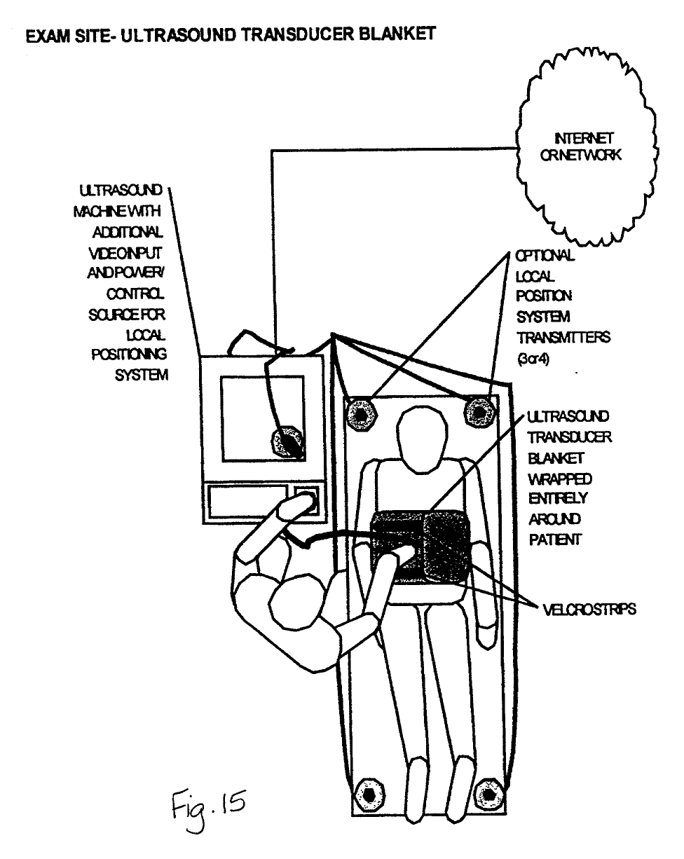

(See FIG. 15—Exam Site—Ultrasound Transducer Blanket)

Each Transducer Assembly may have a Global Positioning System

Global Positioning System with Higher Resolution (Local System) Allows 3D Imaging!

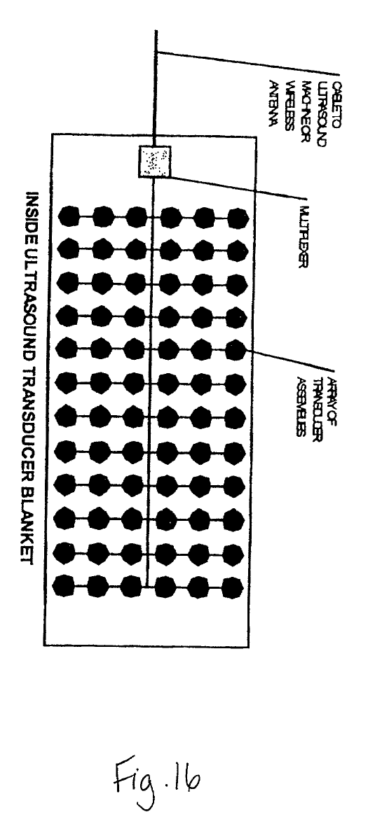

(See FIG. 16—Inside Ultrasound Transducer Blanket)

Transducer Assembly Diagram

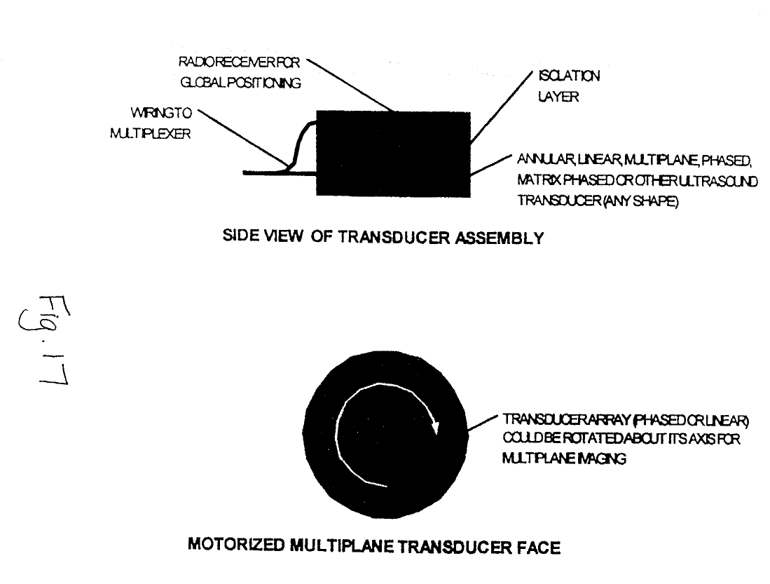

(See FIG. 17)

Ultrasound Blanket could be a Pad

Multiple Transducers Embedded in Pad that is Placed at Strategic Points on the Body

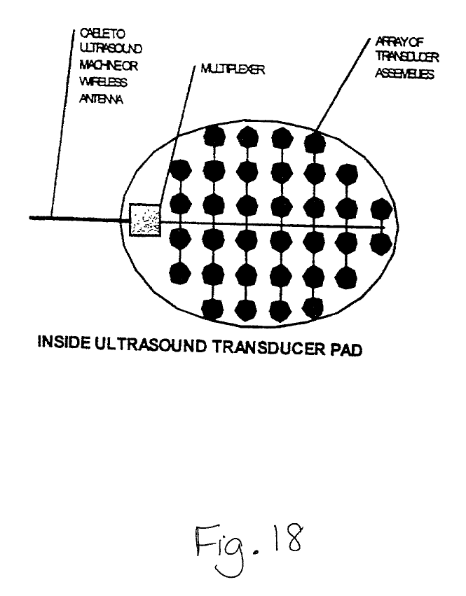

(See FIG. 18—Inside Ultrasound Transducer Pad)

Pad has Strap to Keep it Stationary

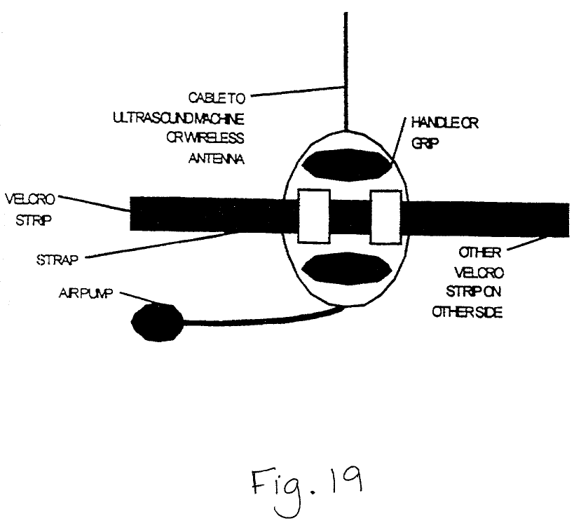

(See FIG. 19)

Blanket (or Pad) is Inflated Similarly to the Blood Pressure Sleeve to

Blanket (or Pad) is Inflated Similarly to the Blood Pressure Sleeve to Ensure Good Coupling to the Body

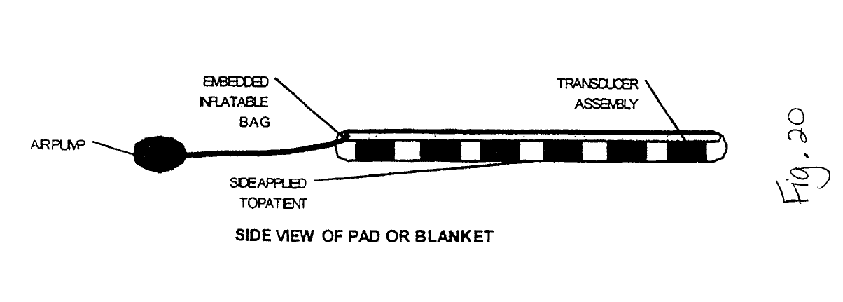

(See FIG. 20)

Ultrasound Exam Procedure

Ultrasound Coupling Gel is Applied to Entire Surface of Pad or Blanket

Pad or Blanket is then Placed on Area of Interest

If Needed, Pad or Blanket is Strapped to Patient

If Needed, Pad or Blanket is then Inflated to Ensure Proper Pressure Against Body

Ultrasound Images Gathered and Processed

Ultrasound Machine may be Smaller or have Wireless Functionality!

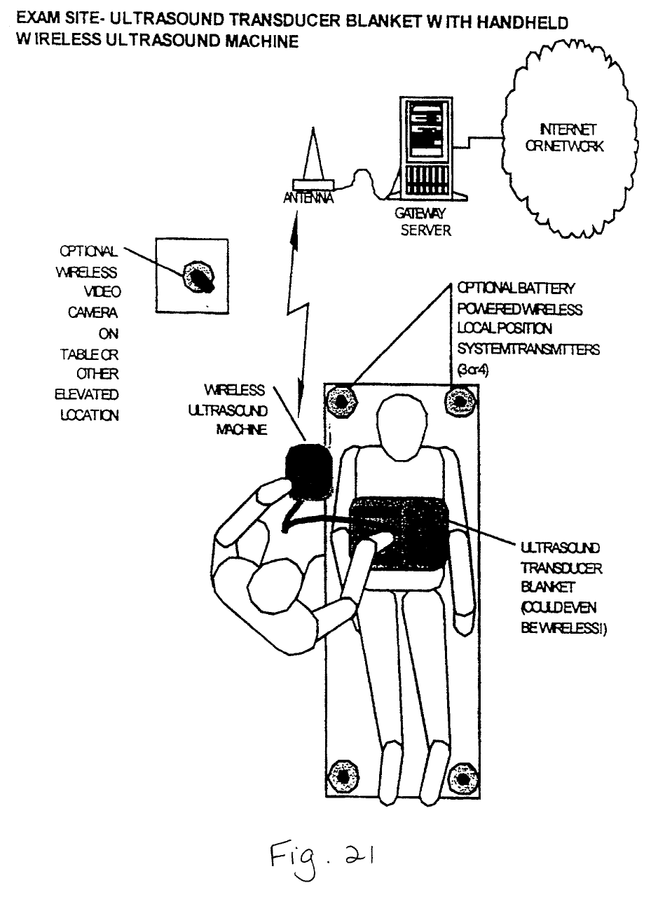

(See FIG. 21)

WebAngel Software

Pre-Fetching Engine Gathers Information in Advance

Uses Currently Viewed Content for Links to Other Web Sites

Timer Driven Automatic Update

Favorite Refresh Automatic Update

Environmental Change Automatic Update

Adaptable Feature Configuration

Automatic Push

Changing Conditions Where WebAngel Automatically Forward

Caches, Pushes or Modifies the Feature Configuration

| | | |
|---|---|---|
| Time of Day/Week/Year | Time Since Last | Weather |
| | Content Update | |
| Velocity | Acceleration/ | Location |
| | Deceleration | |
| Specific User/Owner | Security | Other Safety |
| | | Constraints/Danger |
| Vibration/Impact/ | Ambient Noise | Humidity |
| Earthquakes | | |
| Pitch | Depth | Altitude |
| Device Temperature | Ambient Temperature | Client or Server |
| | | Temperature |
| Nuclear Radiation | Other Conditions of | EMI/RFI |
| | Devices | |
| Wind Velocity | Odor Detection | Ambient Light |
| Chemical Detection | Construction | Detour |
| Service/Fuel Availability | Dust/Pollution | Plague/Pestilence |
| New Laws/Judicial/ | Scheduled Time/Event | Health of Person or |
| Government | | People |
| X-Rays | Gamma Rays | Ultrasound |
| Traffic | Rioting | Wetness |
| Spectral Content of Light | Spectral Content of | Acts of God |
| | Sound | |
| E-mail | Network Messages | New User Input |
| Diagnostic Failure of a | Internet Web Site | Server Traffic on |
| Device | “Hits” | Network |
| Client Traffic on Network | Internet Traffic | Changes in Internet |
| | | Content |

Connection Arbitration

WebAngel Automatically “Finds” Most Appropriate Wireless Protocol

Example.: Kniest Device Needs to Connect to Internet. Kniest Device has two protocols for Wireless Connection. Bluetooth and BellSouth™. WebAnel would “Search” for Bluetooth Server First (which may be Free), then Wireless Network Supplied by say, BellSouth™ which may have Connection Charges

Image Enhancements

Edge Detection

Line Interleave

Grayscale Adjustment

Chroma

Multiple Displays

Pan and Zoom

Image Measurements

Distance

Area

Volumes

Velocity (Medical Application)

User Agent Software

The following diagram illustrates how WebAngel fits into the host software:

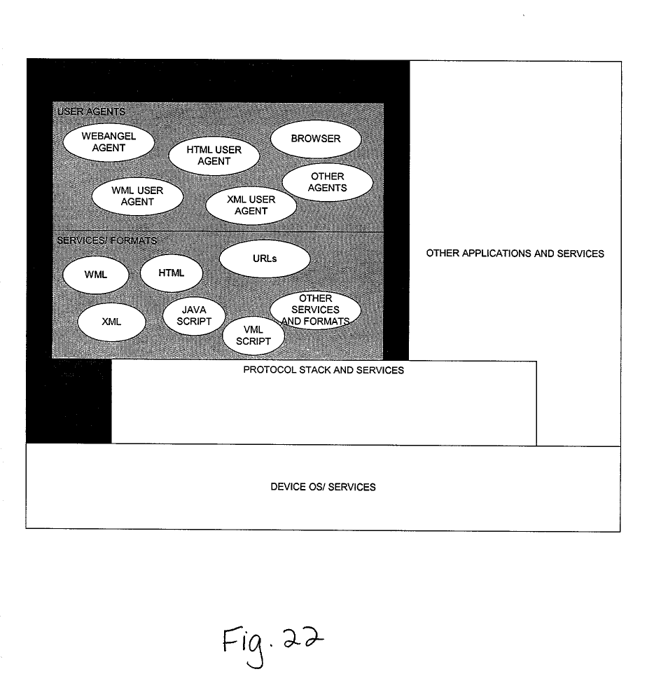

(See FIG. 22)

WebAngel includes any of the above user agents or services/formats.

User Agent Software on World Wide Web

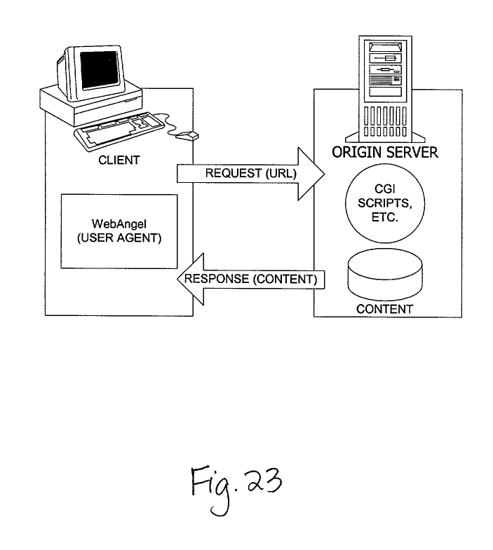

(See FIG. 23—WWW Logical Model)

Wireless Device Context

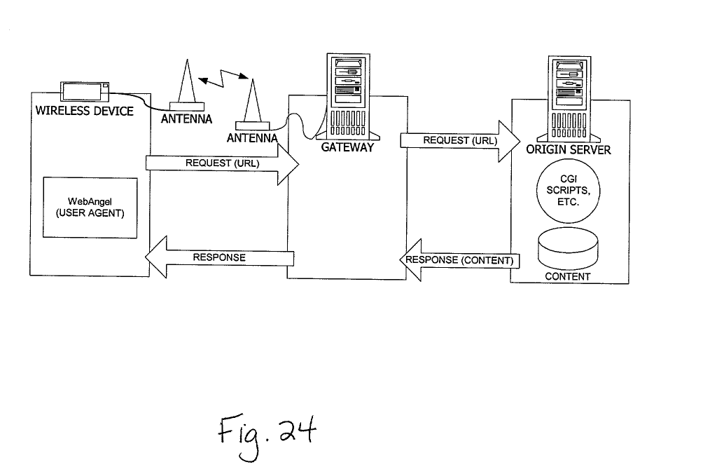

(See FIG. 24—WWW Wireless Logical Model Without Encoding or Decoding Data)

WebAngel Utilizing Encoded Data

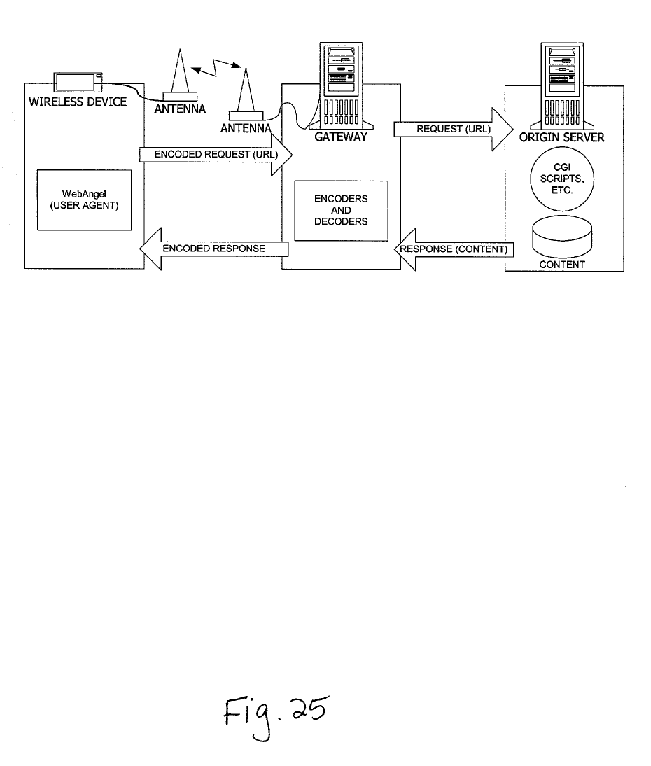

(See FIG. 25—WWW Wireless Logical Model)

WebAngel Running Partially on Server(s) (Encoded or Decoded)

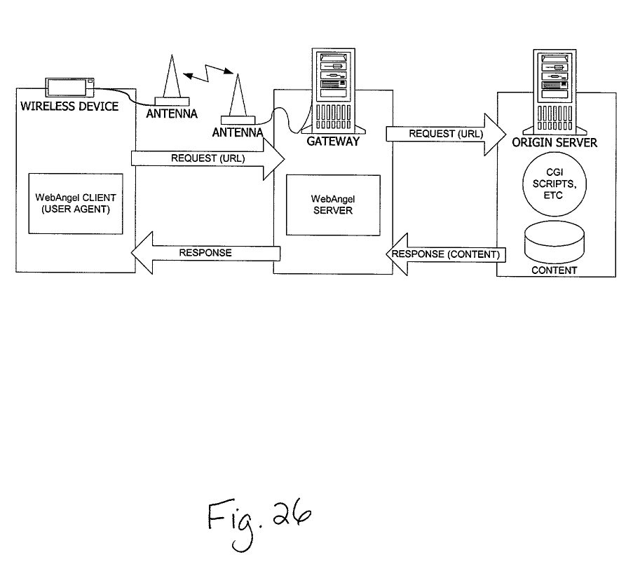

(See FIG. 26—WWW Wireless Logical Model With WebAngel Client and Server)

Data in this case is processed on another device (through a network, Intranet or over the web also):

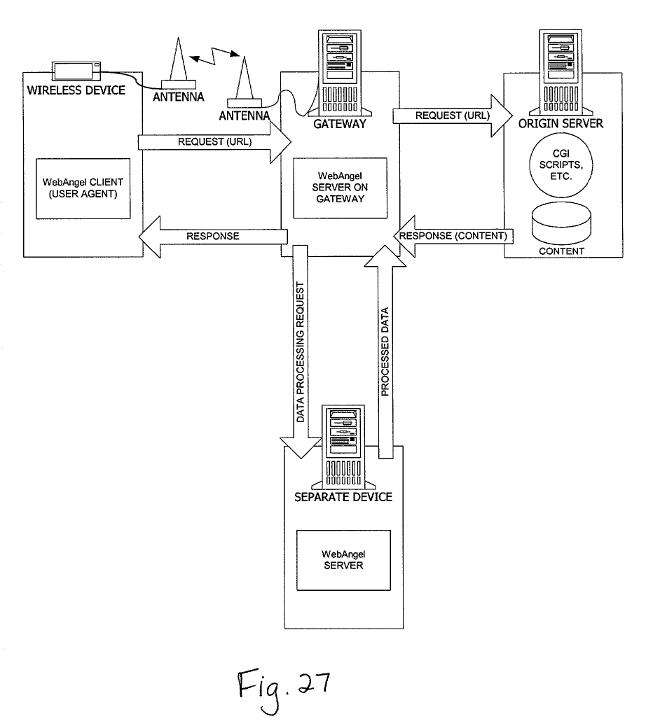

(See FIG. 27—WWW Wireless Logical Model With WebAngel Server on Multiple Devices)

Data processing in the above case means converting it to another format for transmission or interpreting the content and refining it for the client.

WebAngel Software Detailed Description

Cache Forward Engine Gathers Information in Advance Uses Currently Viewed Content for Links to Other Web Sites

WebAngel pre-fetches or “forward caches” data. For example, the browser (which may or may not be part of WebAngel) reports back that there is interest in a specific area of information (which means it is being displayed or TTS to the user). WebAngel monitors how long the user “listens” or views a specific card (or area of the web page), which might have hyperlinks to other content. WebAngel then pre-fetches or forward caches the new information to be split into cards ready for viewing and/or text to speech.

Another example is as follows: The user loads a web page. As it is being downloaded (and displayed) the user reads (or listens to) the web page and its contents. If the user comes across something of interest, he/she may “highlight” or “select” an area that he/she is reading to give some feedback to the browser or WebAngel that this subject is of interest. WebAngel “looks” through the content for any links that are in that area and then fetches them (without output) while the user continues to read the current page.

At some time later, the user either selects a new area of interest in the current page/card or “selects related pages” to download. If the user selects the hyperlink that is already downloaded, it is then ready for review. Selection is done with a “mouse” like device, pointer, keyboard, clicker, buttons or speech. Selection also means WebAngel keeps tract of how long the card is being displayed or read. If it is long enough, WebAngel may search the current card for links to other content and start the Forward Cache process from there.

WebAngel is capable of being commanded to “store” up information requests, and download them as fast as possible for later viewing/listening. For example, the user may want to download all songs written and performed by Elton John. WebAngel then is “started” at some address by the user and start searching ALL links at that site. It then downloads any “hits” and stores as many as possible on some medium like a hard disk, or CD/ROM, etc. Any other sites that are linked to the original may have other links are searched automatically.

Timer Driven Automatic Update

WebAngel is configurable to fetch Internet content automatically based on the time of day or some other event has occurred.

Favorite Refresh Automatic Update

WebAngel is configurable to automatically fetch Internet content “favorites” based on a timer or any of the other conditions listed below.

Environmental Change Automatic Update

If configured properly, environmental changes trigger WebAngel to automatically fetch Internet content “favorites” based on a timer event or any of the other conditions listed below. In this case, WebAngel is a pre-fetching engine (or user agent) that gathers local environmental parameters, sends them to an “analysis module” (part of WebAngel, which may “runs” on a different computer), which arranges for advance sending of only that data that meets the requirement of the environmental data.

Adaptable Feature Configuration

For example, suppose the device that is “running” WebAngel software is a computer in a truck, connected to the World Wide Web over a wireless connection. The computer has other inputs (e.g. Global Position or vehicle sped (MPH) reading) to notify it when the truck is moving or not. If the truck is moving (not parked), WebAngel may be configured to not display pictures or text that may distract the driver and create a safety issue. Instead, WebAngel may output by text to speech (TTS) the textual presentations of the information requested. When parked, WebAngel may be able to show the pictures and text on the display.

Another example may be, when the truck is moving, WebAngel is configured to not pre-fetch or “cache forward”.

Automatic Push

On some event or time (see next section) WebAngel is capable of pushing content to a client (which under “normal” conditions, may be a server or other computer). This may be in the form of e-mail or updated content.

Changing Conditions Where WebAngel Automatically Forward Caches, Pushes or Modifies the Feature Configuration

The table below is a summary of “external” and “internal” conditions which can trigger WebAngel to forward cache, push or modify its feature configuration:

| | | |
|---|---|---|
| Time of Day/Week/Year | Time Since Last | Weather |
| | Content Update | |
| Velocity | Acceleration/ | Location |
| | Deceleration | |
| Specific User/Owner | Security | Other Safety |
| | | Constraints/Danger |
| Vibration/Impact/ | Ambient Noise | Humidity |
| Earthquakes | | |
| Pitch | Depth | Altitude |
| Device Temperature | Ambient Temperature | Client or Server |
| | | Temperature |
| Nuclear Radiation | Other Conditions of | EMI/RFI |
| | Devices | |
| Wind Velocity | Odor Detection | Ambient Light |
| Chemical Detection | Construction | Detour |
| Service/Fuel Availability | Dust/Pollution | Plague/Pestilence |
| New Laws/Judicial/ | Scheduled Time/Event | Health of Person or |
| Government | | People |
| X-Rays | Gamma Rays | Ultrasound |
| Traffic | Rioting | Wetness |
| Spectral Content of Light | Spectral Content of | Acts of God |
| | Sound | |
| E-mail | Network Messages | New User Input |
| Diagnostic Failure of a | Internet Web Site | Server Traffic on |
| Device | “Hits” | Network |
| Client Traffic on Network | Internet Traffic | |

Image Enhancements

Edge Detection

WebAngel searches the image that is to be displayed for edges, where it then “outlines” the image in black or some other color appropriate to the image. There are many edge detection algorithms already developed for other applications.

Line Interleave

WebAngel takes an image and interleave intermediate pixel data for a better quality image when zoomed up or magnified. For example, here is one algorithm for doing this:

For this example, suppose the image (and display) is 100 by 100 pixels in size. It is desired to zoom up the image to double the image size or quadruple the number of pixels to display. So the new image is 200 by 200 pixels, but only ¼^{th} the zoomed image is displayed at one time due to display size limitations. WebAngel “fills” every other new pixel with half the value from the previous pixel with half the value of the next pixel:

Original Image

P1 P2 P3 P4 P5 . . . P100

P101 P102 P103 P104 P105 . . . P200

New Image

P1 (P1+P2)/2 P2 (P2+P3)/2 P3 (P3+P4)/2 P4 (P4+P5)/2 P5 . . . P100

(P1+P101)/2 ((P1+P2)/2)+((P101+P102)/2)/2 and so on . . .

P101 (P101+P102)/2 and so on . . . P200 (which is now P300)

There are many line interleave algorithms already being used.

Pan and Zoom

PS and Zoom of displayed images since display may be quite small. Panning the image is done with a trackball type device to “move around” the image, or broken into pieces like in the storyboard below, or as done in the TruckPC™ section later in this document.

In the following storyboards, WebAngel has broken Internet content into cards (or received them that way if in WAP format). The operator gets to choose whether or not to view pictures. Only voice commands are shown here for simplicity sake. The “Presentation Manager” discussed below is part of WebAngel, or another application that actually displays the images:

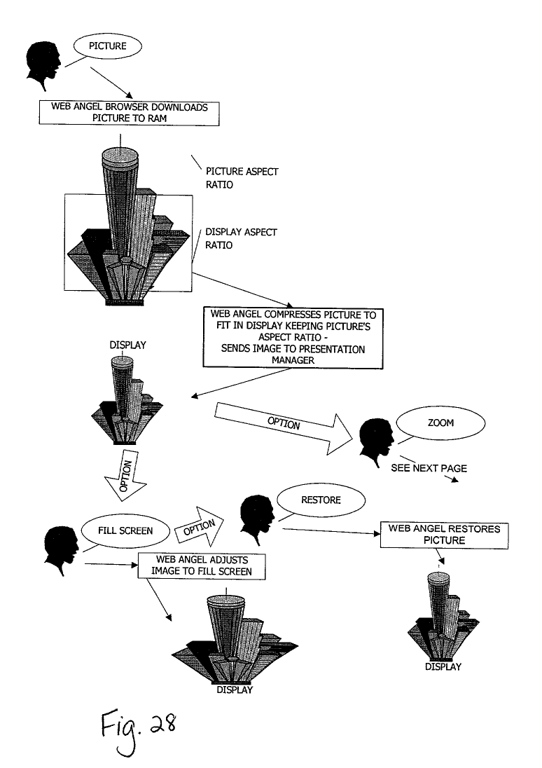

(See FIG. 28)

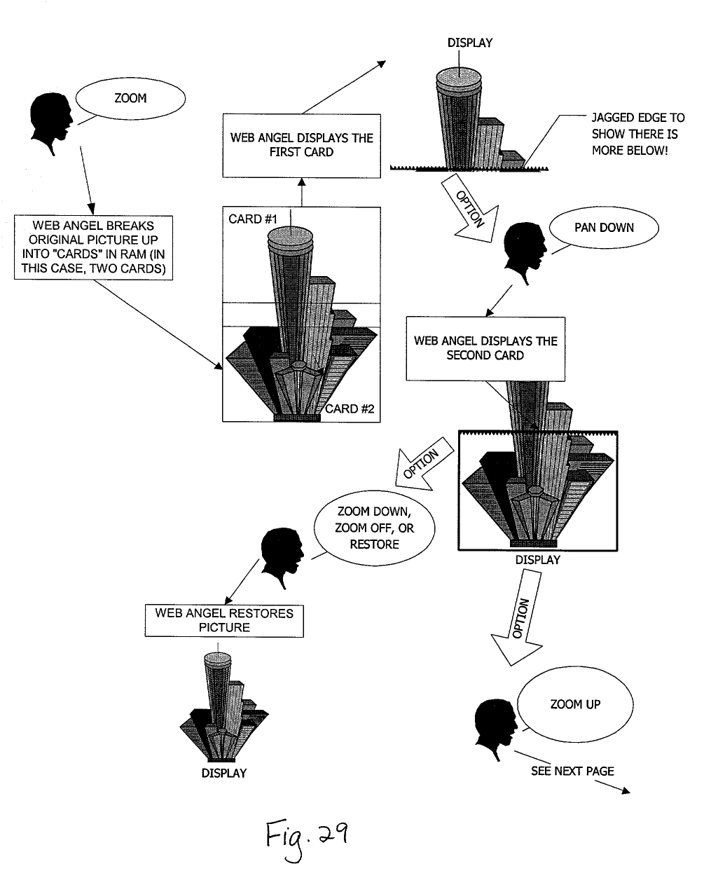

(See FIG. 29)

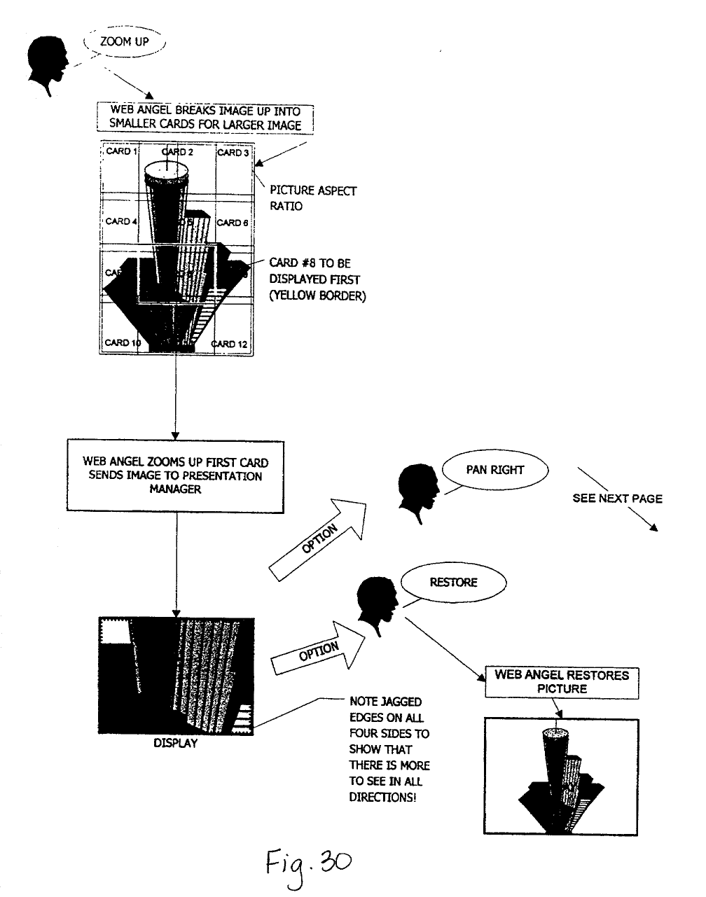

(See FIG. 30)

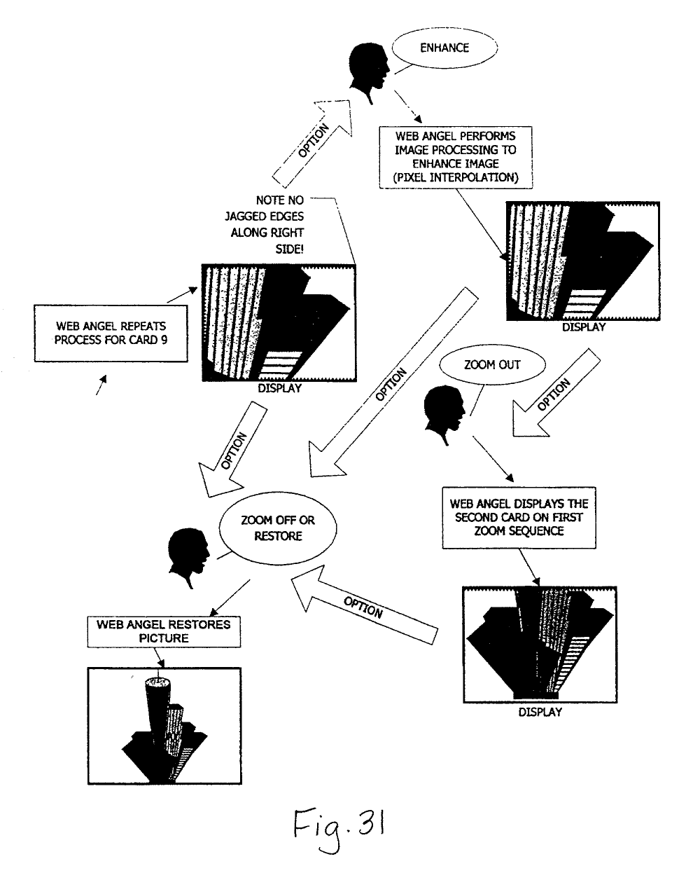

(See FIG. 31)

Grayscale Adjustment

WebAngel allows the user to adjust the gamma curves to allow for better viewing a color image on a black and white display.

Chroma

If the client device has a color display, WebAngel takes a black and white image and assign a gradually darkening color (e.g. blue) instead of black for better visibility. Ultrasound medical devices use this feature to allow detection of subtle gradations of tissue in medical images. The gamma curve adjustment feature is also incorporated (as stated above) in the “Grayscale Adjustment” section.

Multiple Displays

WebAngel is capable of output with one display format, while converting the data for a different display. For example, a computer in a truck may have a black and white primary display (for the driver and passenger) with a color RGB output for a remote display in the sleeper.

Image Measurements

It may be desirable to actually “measure” an object on the display. WebAngel allows the user to place cursors on an image and show the distance between them (based on the information provided for distance per pixel). Areas, velocities (e.g. blood flow) and even volumes of objects on images are estimated using a variety of measurement schemes already developed for medical imaging devices (e.g. ultrasound machines).

Content to Cards for Text Output

See the glossary (Appendix A) for the description of “cards” and “deck”. Output Includes both Displayed Text and Speech (TTS)

Standard Markup Languages/Scripts Parsed Into Cards

SGML

HTML

XML

VML

CGI

Java

Others

Already Parsed Data From Another Source (i.e. WAP)

VML

Tones

The text to speech (TTS) output is configurable to identify when an end of a card has been read, audio file, picture or hyperlink is available. Another way to notify the user “audibly” is to generate different tones for each type of “event”. The tone is generated as an “overlay”, or on top of the text (or just after it).

Pause

WebAngel allows the user to “pause” reading the text or listening to an audio file.

Replay

WebAngel goes back 10 seconds or so, and replay what was just listened to.

Deck Navigation

As stated earlier, the web based content is divided up into cards by either WebAngel, another user agent, or done already in the WAP environment. WebAngel then allows the user to navigate the deck with the following features:

Go-Back or Skip

WebAngel allows the user to move to other cards backwards and forwards.

Seek

The user may have just the first line or phrase of each card read. WebAngel then automatically switches to the next card and repeats the process, until the user disables this feature to “stay” on the current card or stop the whole process. It also cab be set up to read (display) each card for a specified amount of time before switching to the next one. WebAngel identifies each new card with either a tone, text on the display or speech. If the seek feature finishes with the last card, it starts with the first one again, or prompts the user that the end has been reached with a tone, displayed text or speech.

Find Key Word

WebAngel searches the deck for key word(s) or phrases that the user specifies. It may do this before displaying/reading any of the cards in the deck, or at any time during the “card reading/displaying” process. Once found, the card is displayed/read to the user as the new starting point.

Web Browsing with Wireless Devices

General Description

The content is in SGML, HTML, XML or VML format (so that it can be read on a standard VGA display also). The browser handles CGI, Java Scripts and VMLScript.

Saving Web Pages

The user can able to save at least eight web pages in flash memory.

Browsing

The look and feel of the browser is outlined in the next few pages.

Typical Web Page

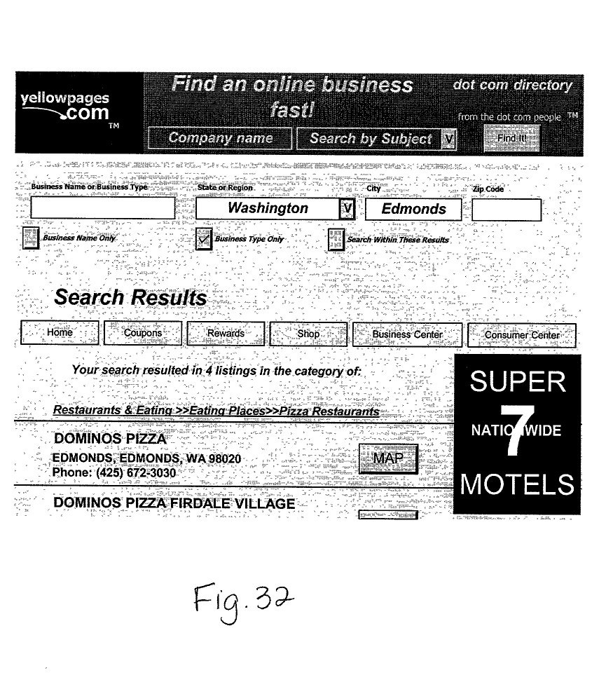

(See FIG. 32)

Fit it into a PDA-sized Small Space!

A Quarter of the Full VGA Output Fits!

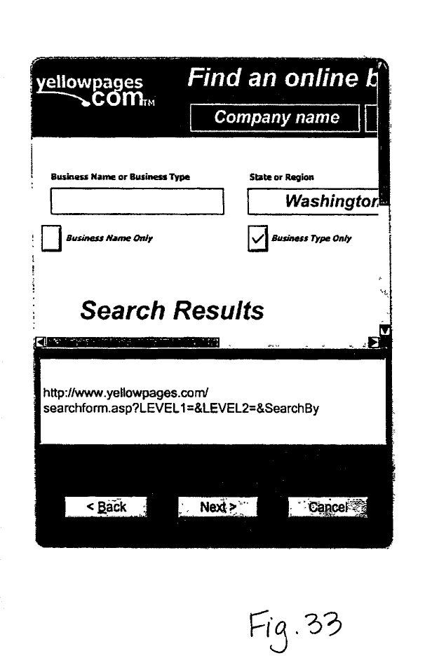

(See FIG. 33)

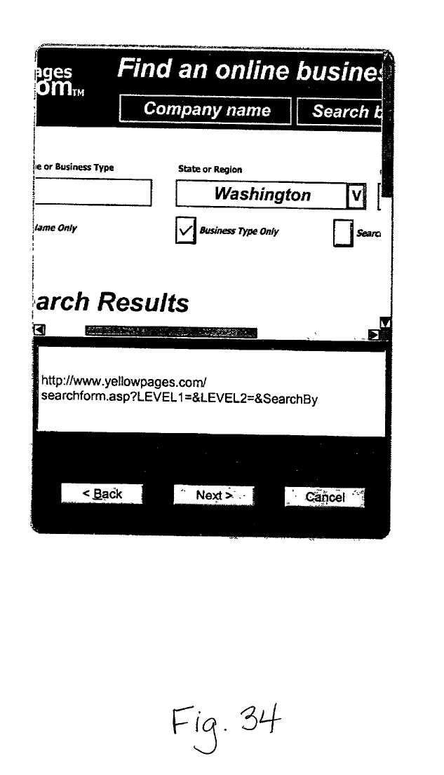

(See FIG. 34)

User Taps Horizontal Scroll Bar to Move Image Right

Another Tap Puts the Web Page in the Center Horizontally

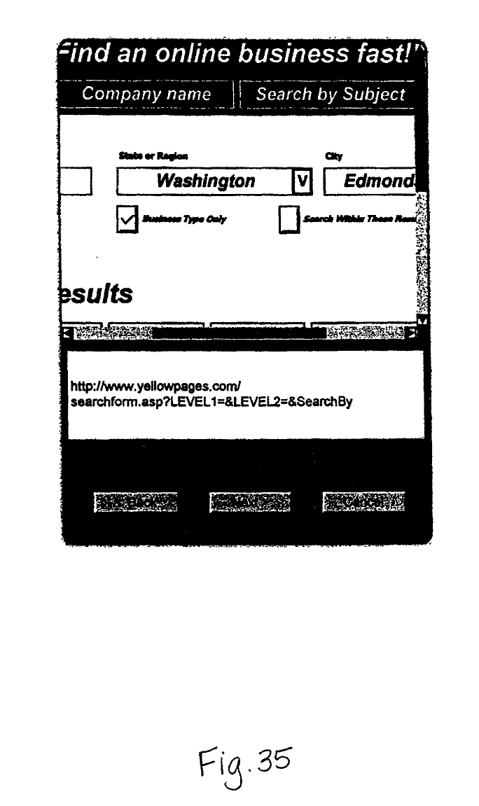

(See FIG. 35)

Vertical Scroll Bar All the Way Down, Horizontal Bar to the Left

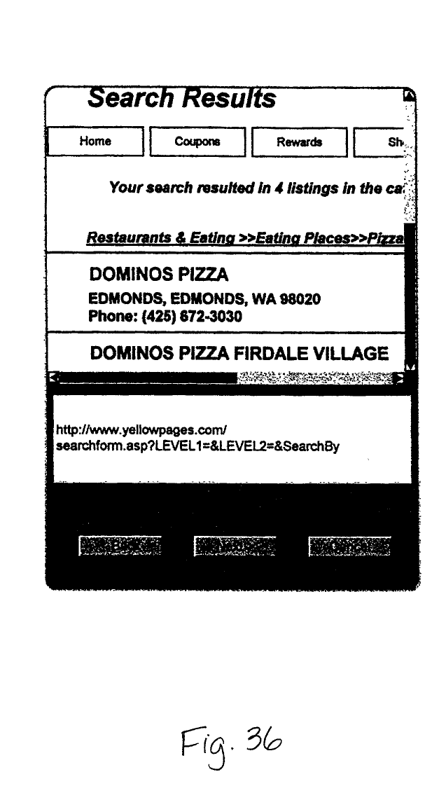

(See FIG. 36)

Text Entry Using Stylus

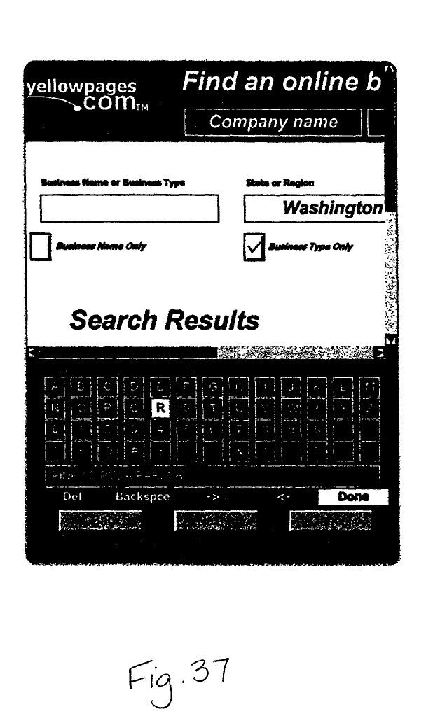

(See FIG. 37)

E-Mail Web Site Links

The browser can to “go to” a site from a hyperlink contained in an e-mail message.

Browser Configuration

Favorite Web sites

As stated earlier, the user can add/remove at least eight favorite web sites.

If there are already eight web sites saved, the user is prompted with the following on the display: “Maximum sites have been saved. Would you like to delete an older one?” If the user responds with the “No” button, the sequence is aborted and the computer waits for the user to continue browsing.

Conversely, if the user responds presses the “Yes” soft key, the browser displays in menu format the first of the eight sites already saved and then allow the user to delete the unwanted one. If none are “over-written” then the browser starts with the first one again. The operator at any time can abort the sequence.

Sound File Playback

When a sound file is available, the web browser notifies the user that it is available. If the user selects playing it (in this case with the stylus), the file is output through the audio system.

While the sound file is being played, the display shows: “Sound File XXX”. Buttons for stopping (and pause) the playback must be made available.

Text to Speech (TTS)

Some devices have the text to speech feature. Buttons are provided to “play” the text on the display through the audio system. Buttons for stopping (and pause) the playback are also available.

Help

Anytime the help button is pressed the browser displays what functionality the soft and hard keys provide.

Wearable Wireless Devices

Any of the Above Kniest Wireless Devices Wearable on Body!

Portable “Movie Screens” for Larger Images (Even Full VGA!)

Internal Video Projection Device for Screen or Wall

Projection Video can be Turned off to Save Power

Small Embedded Liquid Crystal Display Included for Control

Other Models may have Buttons or “Mousepad” Device

Tape or CD Drives are in Separate Enclosure Worn on Different Part of Body

Connected to “Control Unit” (with Display) by Bluetooth Wireless or Other Radio Frequency Protocol

Worn on Forearm Wireless Device

Strap Detachable, so Unit can sit on Table

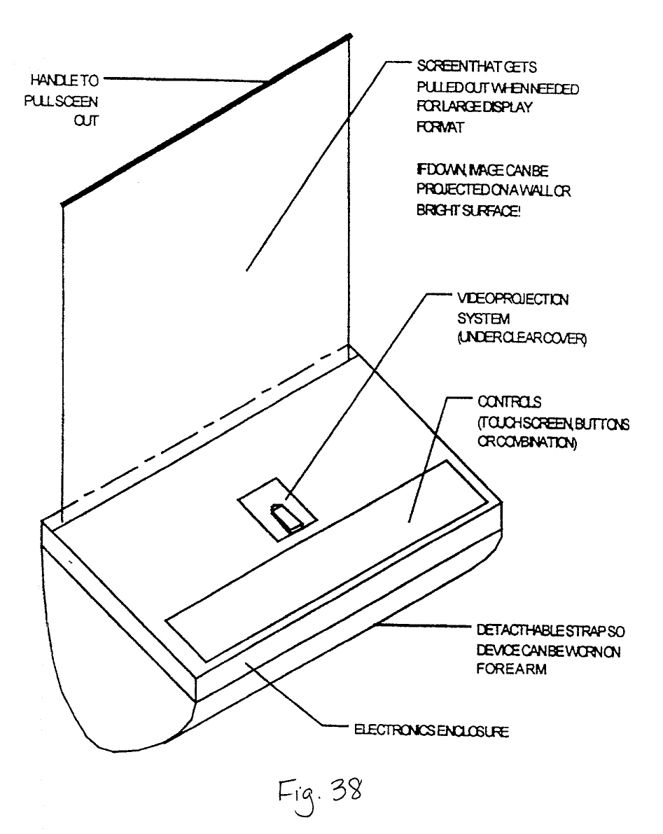

(See FIG. 38)

Another Version: Display Driven from the Rear For Smaller Form Factor

Video Reversible, for Both Modes of Operation (Wall or Screen)

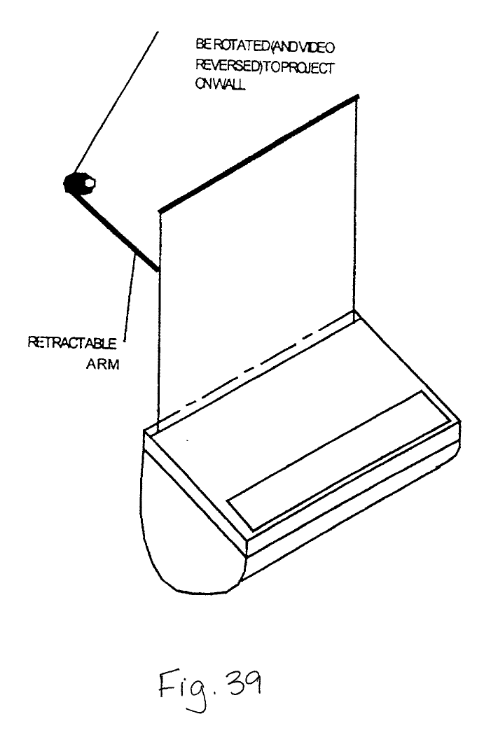

(See FIG. 39)

Another Version (not shown) has Projector Mounted on Small Portable Stand that can be Projected on Desk or Wall.

Wireless Link (Bluetooth) with Device

Stand and Video Projector is Stored in Device when not Needed or Carried Separately

Strap Made of Gore-Tex® Type Material to Minimize Sweating

Bottom of Electronics Enclosure also Gore-Tex Where it Meets Skin

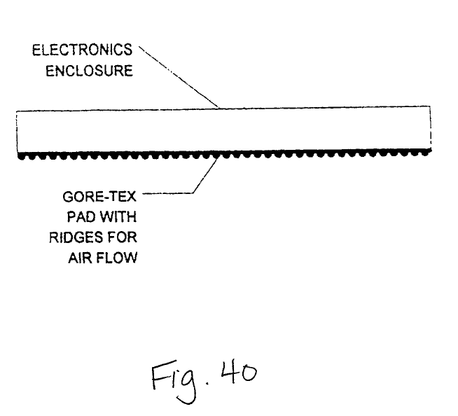

(See FIG. 40—Side View of Electronics Enclosure)

APPENDIX A
Glossary of Terms and Acronyms

| Term/Acryonym | Description |
|---|---|
| API | Application Programming Interface |
| FTL | Freightliner |
| GPS | Global Positioning System |
| HTML | Hyper Text Markup Language |
| HTTP | Hyper Text Transfer Protocol |
| IP | Internet Protocol |
| MS | Microsoft |
| OEM | Original Equipment Manufacturer |
| PC | Personal Computer |
| RAM | Random Access Memory |
| ROM | Read Only Memory |
| SAE | Society of Automotive Engineers |
| SRS | Software Requirements Specifications |
| TBD | To Be Defined |
| TCP/IP | Transmission Control Protocol/Internet Protocol |
| TMC | The Maintenance Council |
| TTS | Text to Speech |
| USB | Universal Serial Bus |
| WWW | World Wide Web |
| Card | A single markup language (e.g. WML, HTML) unit of |
| | navigation and user interface. May contain information |
| | to present to the user, instructions for gathering user |
| | input, etc. |
| Client | A device (or application) that initiates a request for |
| | connection with a server. |
| Client Server | Communication between a client and a server. |
| Communication | Typically the server performs a task (such as |
| | generating content) on behalf of the client. Results of |
| | the task are usually sent back to the client (e.g., |
| | generated content.) |
| Content | Synonym for data objects. |
| Content Encoding | When used as a verb, content encoding indicates the |
| | act of converting a data object from one format to |
| | another. Typically the resulting format requires less |
| | physical space than the original, is easier to process or |
| | store and/or is encrypted. When used as a noun, |
| | content encoding specifies a particular format or |
| | encoding standard or process. |
| Content Format | Actual representation of content. |
| Content | A service that generates or formats content. Typically |
| Generator | content generators are on origin servers. |
| Deck | A collection of markup language (e.g. WML, HTML) |
| | cards. A deck may also be an XML document. May |
| | contain WMLScript or JavaScript |
| Device | A network entity that is capable of sending and |
| | receiving packets of information and has a unique |
| | device address. A device can act as both a client and a |
| | server within a given context or across multiple |
| | contexts. For example, a device may service a number |
| | of clients (as a server) while being a client to another |
| | server. |
| Distance root | The root-mean-square value of the distances from the |
| mean square | true location point of the position fixes in a collection |
| (drms) | of measurements. As typically used in GPS |
| | positioning, 2 drms is the radius of a circle that |
| | contains at least 95 percent of all possible fixes that |
| | can be obtained with a system at any one place. |
| GPS | The U.S. Department of Defense Global Positioning |
| | System: A constellation of 24 satellites orbiting the |
| | earth at a very high altitude. GPS satellites transmit |
| | signals that allow one to determine, with great |
| | accuracy, the locations of GPS receivers. The receivers |
| | can be fixed on the Earth, in moving vehicles, aircraft, |
| | or in low-Earth orbiting satellites. GPS is used in air, |
| | land and sea navigation, mapping, surveying and other |
| | applications where precise positioning is necessary. |
| GPS ICD-200 | The GPS Interface Control Document is a government |
| | document that contains the full technical description of |
| | the interface between the satellites and the user. |
| JavaScript | A de facto standard language that may be used to add |
| | dynamic behaviour to HTML documents. JavaScript is |
| | one of the originating technologies of ECMAScript. |
| Modem | A modulator/demodulator. When two computers |
| | communicate over telephone lines and similar media, |
| | digital signals must be converted to analog during |
| | transmission, then back again to digital at the |
| | destination. Modems are always used in pairs, one at |
| | each end. They are rated according to the speed, |
| | typically in “bits per second,” at which the |
| | information can pass through the transmission |
| | medium. |
| Origin Server | The server on which a given resource resides or is to |
| | be created. Often referred to as a web server or HTTP |
| | server. |
| Pre-Fetch | In this case, WebAngel software “looks and |
| | downloads” Internet content automatically. |
| Push | Unsolicited “sending of information” to a client |
| | device. |
| Resource | A network data object or service that may be identified |
| | by a URL. Resources may be available in multiple |
| | representations (e.g., multiple languages, data formats, |
| | size and resolutions) or vary in other ways. |
| Server | A device (or application) that passively waits for |
| | connection requests from one or more clients. A server |
| | may accept or reject a connection request from a |
| | client. |
| SGML | The Standardised Generalised Markup Language |
| | (defined in [ISO8879]) is a general purpose language |
| | for domain specific mark up languages. |
| Standard | The normal civilian positioning accuracy obtained by |
| Positioning | using the single frequency C/A code. Under selective |
| Service (SPS) | availability conditions, guaranteed to be no worse than |
| | ˜10 meters 95 percent of the time (2 drms). |
| User | A user is a person who interacts with a user agent to |
| | view, hear or otherwise use a resource. |
| User Agent | A user agent is any software or device that interprets |
| | content (e.g., WML, XML, SGML, HTML). This may |
| | include textual browsers, voice browsers, search |
| | engines, etc. |
| WebAngel | WebAngel is the trademark for a kind of computer |
| | software package that runs “on top” of a World Wide |
| | Web browser (a user agent). It controls the user agent |
| | software, or it incorporates a browser. It is to be |
| | considered just part of the user agent, or all of it |
| | depending on the application. |
| WebAngel Client | Software subset of WebAngel software that runs on the |
| | client. |
| WebAngel Server | Software subset of WebAngel software that runs on a |
| | server. NOT DONE FOR THIS APPLICATION |

I claim:

1. A system for wireless exchange of data with hand held devices comprising a hand held device having operatively installed therein a browser and at least one user agent, the device wirelessly connected to a wireless gateway server, the gateway server operatively connected to an origin server via a global information exchange network.
